(19) United States
(12) Patent Application Publication
(10) Pub. No.: US 2010/0118297 A1
(43) Pub. Date: May 13, 2010

(54) MICROSCOPE HAVING MULTIPLE IMAGE-OUTPUTTING DEVICES AND PROBING APPARATUS FOR INTEGRATED CIRCUIT DEVICES USING THE SAME

(75) Inventors: YONG YU LIU, HSINCHU CITY (TW); CHOON LEONG LOU, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: STAR TECHNOLOGIES INC., HSINCHU CITY (TW)

(21) Appl. No.: 12/689,599

(22) Filed: Jan. 19, 2010

Related U.S. Application Data
(63) Continuation-in-part of application No. 12/015,775, filed on Jan. 17, 2008.

(30) Foreign Application Priority Data
Nov. 21, 2007 (TW) 096144013

(51) Int. Cl. G01N 21/956; G02B 21/18; G02B 21/02

(52) U.S. Cl. 356/237.5; 359/372

(57) ABSTRACT

A microscope includes an object splitter configured to split the object image into a first optical path and a second optical path, a first imaging module positioned on the first path and a second imaging module positioned on the second path. The object splitter includes a first beam splitter configured to direct an illumination light to an object, an objective lens configured to collect the reflected light from the object and couple the reflected light on the first beam splitter, and a second beam splitter configured to split the reflected light into the first optical path and the second optical path, wherein the distance between the object and the objective lens is constant. The first imaging module includes a first close up lens configured to render a first object image to a first imaging device with auto-focusing and remote-zooming capabilities, and the second imaging module includes a second close up lens and a negative lens configured to render a second object image to a second imaging device with auto-focusing and remote-zooming capabilities.

The present application is a continuation-in-part of U.S. patent application Ser. No. 12/015,775, filed on Jan. 17, 2008, the disclosure of which is incorporated herein by reference.

### BACKGROUND OF THE INVENTION

(A) Field of the Invention

The present invention relates to a microscope having multiple image-outputting devices and a probing apparatus for an integrated circuit device using the same, and more particularly, to a microscope having multiple image-outputting devices for displaying object images of different magnifications with auto-focusing and remote-zooming and a probing apparatus for an integrated circuit device using the same.

(B) Description of the Related Art

Optical microscopes are adapted for viewing objects on planar surfaces of glass slides. Such microscopes generally include an optical system, which provides an image of the object in an associated focal plane. The optical components of an optical microscope are two imaging lenses (eyepiece and objective) and a condenser lens. The eyepiece and objective are utilized for magnifying the image of the specimen and projecting it onto the viewer's retina or onto the film plane in a camera. The condenser lens serves to focus a cone of incident light onto the specimen. To provide the incident light, there is an illumination system that may include the source of the incident light or may direct external natural or artificial light towards the condenser lens. The illumination system can also provide means for enhancing the contrast and detail seen in the image. Finally, there is a movable stage, which holds the specimen in the optical path and allows the specimen to be moved in and out of the focal plane, moved to the left or right, or rotated about the optic axis.

U.S. patent publication number 2005/0094021 A1 discloses an optical system incorporating an auto-focus camera with built-in close-up optics for easy coupling to any imaging optical system via a standard C-mount; however, such system has the drawback of having only one optical path and thus is only a single view system.

### SUMMARY OF THE INVENTION

One aspect of the present invention provides a microscope having multiple image-outputting devices for displaying object images of different magnifications and fields of view and a probing apparatus for an integrated circuit device using the same.

A microscope according to this aspect of the present invention comprises an object splitter configured to split the reflected light from an object plane into a first optical path and a second optical path, a first imaging module positioned on the first path and a second imaging module positioned on the second path. In one embodiment of the present disclosure, the object splitter includes a first beam splitter configured to direct an illumination light to the object plane, an objective lens configured to collect the reflected light from the object plane and couple the reflected light on the first beam splitter, and a second beam splitter configured to split the reflected light into the first optical path and the second optical path, wherein the distance between the object plane and the objective lens is constant. The first imaging module comprises a first close up lens positioned on the first optical path and configured to render a first object image to a first imaging device with auto-focusing and remote-zooming capabilities, and the second imaging module comprises a second close up lens and a negative lens positioned on the second optical path and configured to render a second object image to a second imaging device with auto-focusing and remote-zooming capabilities.

Another aspect of the present invention provides a probing apparatus for an integrated circuit device comprising at least one probe pin configured to contact a pad of the integrated circuit device and a microscope having multiple image-outputting devices for displaying the images of the probe pin contacting the pad at different magnifications with auto-focusing and remote-zooming. In one embodiment of the present invention, the microscope comprises an object splitter, a first imaging module and a second imaging module. The object splitter includes a first beam splitter configured to direct an illumination light to an object plane, an objective lens configured to collect a reflected light from the object plane and couple the reflected light on the first beam splitter, and a second beam splitter configured to split the reflected light into a first optical path and a second optical path, wherein the distance between the object plane and the objective lens is constant. The first imaging module comprises a first close up lens positioned on the first optical path and configured to render a first object image to a first imaging device with auto-focusing and remote-zooming capabilities, and the second imaging module comprises a second close up lens and a negative lens positioned on the second optical path and configured to render a second object image to a second imaging device with auto-focusing and remote-zooming capabilities.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 illustrates a microscope according to one embodiment of the present invention;

FIG. 2 and FIG. 3 show the object images acquired by the microscope at different magnifications; and

FIG. 4 illustrates a probing apparatus for an integrated circuit device according to one embodiment of the present invention.

### DETAILED DESCRIPTION OF THE INVENTION

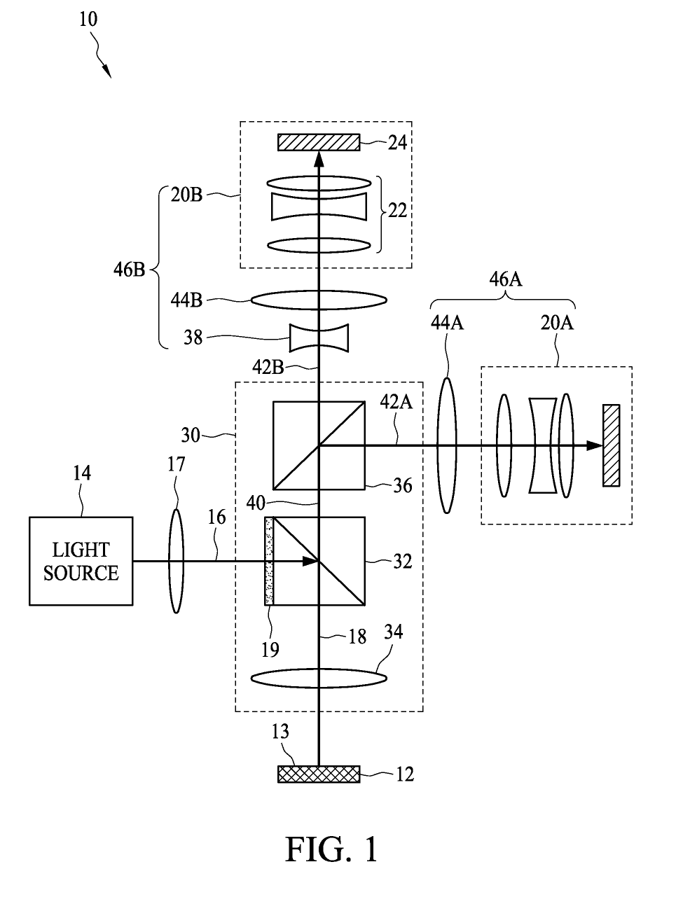

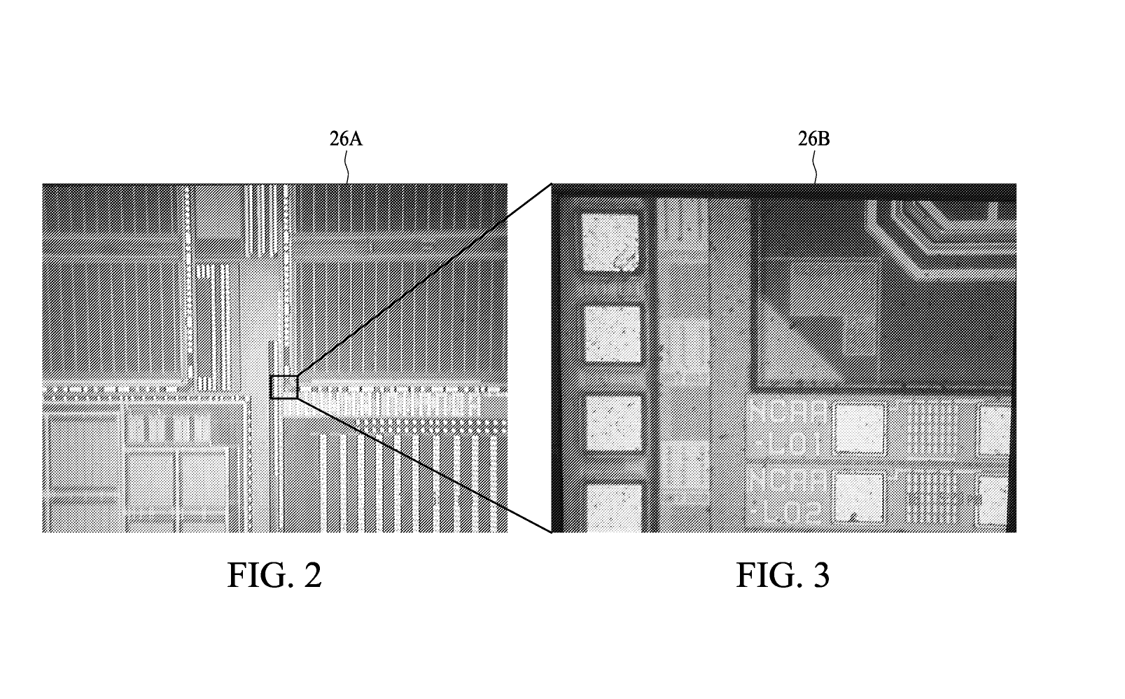

FIG. 1 illustrates a microscope 10 according to one embodiment of the present invention, and FIG. 2 and FIG. 3 show the object images acquired by the microscope 10. The microscope 10 comprises an object splitter 30 configured to split a reflected light from an object plane 13 into a first optical path 42A and a second optical path 42B, a first imaging module 46A positioned on the first path 42A and a second imaging module 46B positioned on the second path 42B. In one embodiment of the present disclosure, the object splitter 30 includes a first beam splitter 32 configured to direct an illumination light 16 to the object plane 13, an objective lens 34 configured to collect the reflected light 18 from the object plane 13 and couple the reflected light 18 on the first beam splitter 30, and a second beam splitter 36 configured to split the reflected light 18 into the first optical path 42A and the second optical path 42B. The first imaging module 46A comprises a first close up lens 44A positioned on the first optical path 42A and configured to render a first object image 26A (FIG. 2) to a first imaging device 20A with auto-focusing and remote-zooming capabilities, and the second imaging module 20B comprises a second close up 44B lens and a negative lens 38 positioned on the second optical path 42B and configured to render a second object image 26B (FIG. 3) to a second imaging device 46B with auto-focusing and remote-zooming capabilities.

In one embodiment of the present disclosure, the microscope 10 includes a positive lens 17 such as a condenser lens positioned between the first splitter 32 and a light surface 14 emitting the illumination light 16, and a diffuser 19 disposed on a surface of the first splitter 32 receiving the illumination light 16. Preferably, the first beam splitter 32, the objective lens 34 and the second beam splitter 36 are positioned on an optical axis 40, and the object splitter 30 is configured to direct the illumination light 16 to the object 12 through the optical axis 40. In particular, the objective lens 34 is configured to allow the illumination light 16 to penetrate through to the object 12, and allow the reflected light 18 to penetrate through to the first beam splitter 32. The first beam splitter 32 is configured to allow the reflected light 18 to penetrate through to the second beam splitter 36. Preferably, the first imaging device 20A and the second imaging device 20B have the same configuration, and each includes a plurality of auto-focusing and remote-zooming lenses 22 configured to magnify the object image and an image sensor 24 configured to capture the magnified image. Furthermore, the auto-focusing and remote-zooming lenses 22 also allow continuous zoom adjustments with auto-focus capability. Consequently, the first imaging device 20A and the second imaging device 20B can be used to acquire the object images at different zoom levels individually.

In one embodiment of the present disclosure, the first close up lens 44A is configured to render the first object image 26A of a first magnification, and the second close up lens 44B and the negative lens 38 are configured to render the second object image 26B of a second magnification different from the first magnification, wherein the second magnification is typically greater than the first magnification. In one embodiment of the present disclosure, the first close up lens 44A and the first imaging device 20A are configured to have a first field of view (FOV), and the second close up lens 44B, the negative lens 38 and the second imaging device 20B are configured to have a second field of view different from the first field of view, wherein the second field of view is smaller than the first field of view. In a further embodiment of the present disclosure, the second field of view can be designed to partially overlap the first field of view.

In one embodiment of the present disclosure, the negative lens 38 is positioned between the second splitter 36 and the second close up lens 44B. In a preferred embodiment, the distance between the first imaging device 20A and the object splitter 36 is constant, the distance between the second imaging device 20B and the object splitter 36 is constant, the distance between the object plane 13 and the objective lens 34 is constant; i.e., the distance between the object plane 13 and the objective splitter 30 is constant. In other words, the relative distance between the optical components of the microscope 10 is fixed, and the zooming and focusing of the microscope 10 are implemented in the first imaging device 20A and the second imaging device 20B, such that the microscope 10 can acquire the object images of different magnifications with auto-focusing and remote-zooming for the observes without moving the optical components of the microscope 10.

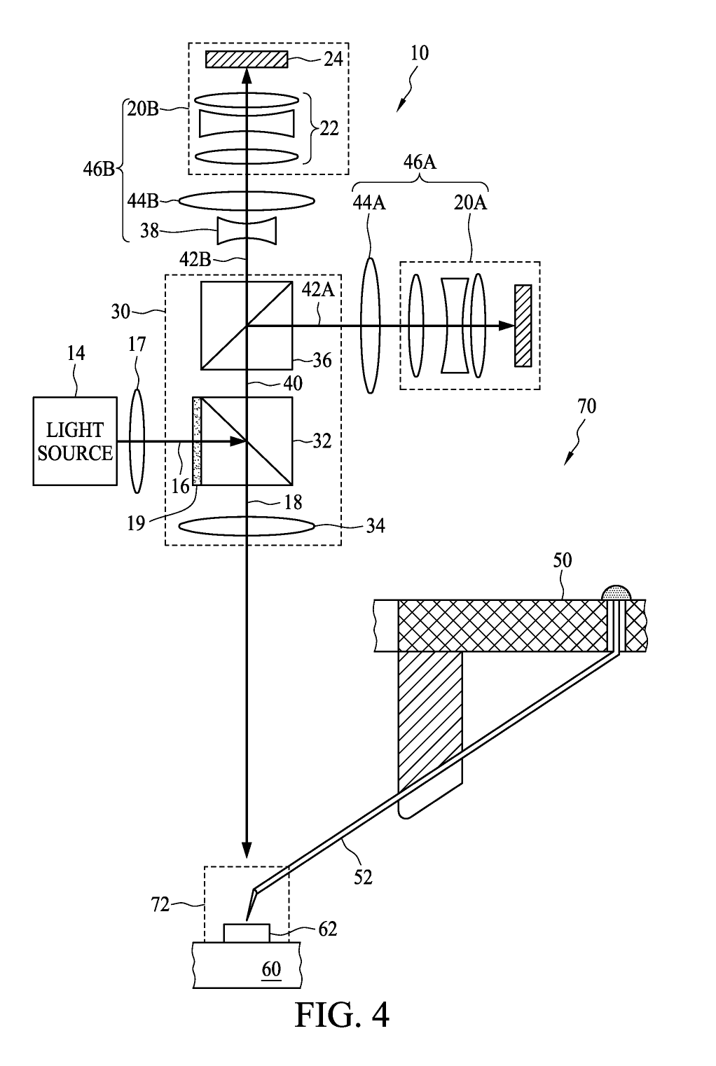

FIG. 4 illustrates a probing apparatus 70 for an integrated circuit device 60 according to one embodiment of the present invention. The probing apparatus 70 can be a probing machine having a platform to receive a probing card 50 including at least one probe pin 52 configured to contact a pad 62 of the integrated circuit device 60 and the microscope 10 configured to show the images of a predetermined region 72 where the probe pin 52 contacts the pad 62 at different zoom levels. In particular, the microscope 10 can simultaneously provide multiple views of the predetermined region 72 and each view with different zoom settings such that the user of the probing apparatus 70 can observe the images of the predetermined region 72 at different zoom levels simultaneously. In addition, the microscope 10 also allows each view to have continuous but separate zoom adjustments with auto-focus capability. Hence, the microscope 10 totally eliminates the need to adjust individual focusing when the probe pin 52 is moved or when zoom settings are changed.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A microscope, comprising:
an object splitter including a first beam splitter configured to direct an illumination light to an object plane, an objective lens configured to collect a reflected light from the object plane and couple the reflected light on the first beam splitter, and a second beam splitter configured to split the reflected light into at least a first optical path and a second optical path;
a first imaging module positioned on the first optical path, the first imaging module including a first close up lens configured to render a first object image to a first imaging device with auto-focusing and remote-zooming capabilities; and
a second imaging module positioned on the second optical path, the second imaging module including a second close up lens and a negative lens configured to render a second object image to a second imaging device with auto-focusing and remote-zooming capabilities.

2. The microscope of claim 1, wherein the first close up lens is configured to render the first object image of a first magnification, and the second close up lens and the negative lens are configured to render the second object image of a second magnification different from the first magnification.

3. The microscope of claim 2, wherein the second magnification is greater than the first magnification.

4. The microscope of claim 1, wherein the first close up lens and the first imaging device have a first field of view, and the second close up lens, the negative lens and the second imaging device have a second field of view different from the first field of view.

5. The microscope of claim 4, wherein the second field of view is smaller than the first field of view.

6. The microscope of claim 4, wherein the second field of view overlaps the first field of view.

7. The microscope of claim 1, wherein the negative lens is positioned between the second splitter and the second close up lens.

8. The microscope of claim 1, wherein the distance between the first imaging device and the object splitter is constant.

9. The microscope of claim 1, wherein the distance between the second imaging device and the object splitter is constant.

10. The microscope of claim 1, wherein the distance between the object plane and the objective lens is constant.

11. The microscope of claim 1, wherein the distance between the object plane and the objective splitter is constant.

12. The microscope of claim 1, further comprising a positive lens positioned between the first splitter and a light surface for emitting the illumination light, and a diffuser disposed on a surface of the first splitter receiving the illumination light.

13. The microscope of claim 1, wherein the first imaging device and the second imaging device have the same configuration.

14. A probing apparatus for an integrated circuit device, comprising:
a probing card including at least one probe pin configured to contact a pad of the integrated circuit device; and
an object splitter configured to direct an illumination light to an object plane in a predetermined region where the probe pin contacts the pad and splits a reflected light from the object plane into at least a first optical path and a second optical path;
a first imaging module positioned on the first optical path, the first imaging module including a first close up lens configured to render a first object image to a first imaging device with auto-focusing and remote-zooming capabilities; and
a second imaging module positioned on the second optical path, the second imaging module including a second close up lens and a negative lens configured to render a second object image to a second imaging device with auto-focusing and remote-zooming capabilities.

15. The probing apparatus for an integrated circuit device of claim 14, wherein the object splitter includes:
a first beam splitter configured to direct the illumination light to the object plane;
an objective lens configured to collect the reflected light from the object plane and couple the reflected light on the first beam splitter, wherein the distance between the object plane and the objective lens is constant; and
a second beam splitter configured to split the reflected light into a first optical path and a second optical path;

16. The probing apparatus for an integrated circuit device of claim 15, wherein the distance between the object plane and the objective lens is constant.

17. The probing apparatus for an integrated circuit device of claim 14, wherein the first close up lens is configured to render the first object image of a first magnification, and the second close up lens and the negative lens are configured to render the second object image of a second magnification different from the first magnification.

18. The probing apparatus for an integrated circuit device of claim 17, wherein the second magnification is greater than the first magnification.

19. The probing apparatus for an integrated circuit device of claim 14, wherein the first close up lens and the first imaging device have a first field of view, and the second close up lens, the negative lens and the second imaging device have a second field of view different from the first field of view.

20. The probing apparatus for an integrated circuit device of claim 19, wherein the second field of view is smaller than the first field of view.

21. The probing apparatus for an integrated circuit device of claim 19, wherein the second field of view overlaps the first field of view.

22. The probing apparatus for an integrated circuit device of claim 14, wherein the negative lens is positioned between the second splitter and the second close up lens.

23. The probing apparatus for an integrated circuit device of claim 14, wherein the distance between the first imaging device and the object splitter is constant.

24. The probing apparatus for an integrated circuit device of claim 14, wherein the distance between the second imaging device and the object splitter is constant.

25. The probing apparatus for an integrated circuit device of claim 14, wherein the distance between the object plane and the objective splitter is constant.

26. The probing apparatus for an integrated circuit device of claim 14, wherein the first imaging device and the second imaging device have the same configuration.
